(19) United States
(12) Patent Application Publication
(10) Pub. No.: US 2026/0091842 A1
(43) Pub. Date: Apr. 2, 2026

(54) Y-Shaped Steering Assembly for a Recumbent Bicycle

(71) Applicant: Chapin Del Sol White, Takoma Park, MD (US)

(72) Inventor: Chapin Del Sol White, Takoma Park, MD (US)

(21) Appl. No.: 19/315,497

(22) Filed: Aug. 30, 2025

Related U.S. Application Data
(60) Provisional application No. 63/700,669, filed on Sep. 28, 2024.

(51) Int. Cl. B62K 21/12; B62K 3/00; B62K 21/18

(52) U.S. Cl. CPC B62K 21/12; B62K 3/005; B62K 21/18

(57) ABSTRACT

A steering assembly for a recumbent bicycle provides a direct underseat steering (USS) assembly that reduces complexity and improves durability compared to linkage-based systems. The assembly includes a head tube having one or more cutouts and a Y-shaped connector that passes through the cutouts to couple a handlebar to the steering tube. The configuration allows the handlebar to rotate freely between upper and lower members of the bicycle frame and the upper and lower sections of the chain, enabling efficient short-wheelbase recumbent designs with a straight chainline. The connector may be secured to the steering tube and handlebar by compression and bolt fittings, and may deflect or rotate under crash forces to reduce permanent damage. The assembly permits intuitive steering input, simplifies manufacturing, and is compatible with equal-sized wheels and standard drivetrain components, thereby addressing prior deficiencies in recumbent bicycle steering systems.

### CROSS-REFERENCE TO RELATED APPLICATIONS

This application claims an invention which was disclosed in Provisional Application No. 63/700,669, filed Aug. Sep. 28, 2024, entitled “Y-shaped Steering Mechanism for a Recumbent Bicycle with Direct Underseat Steering.” The benefit under 35 USC § 119 (e) of the United States provisional application is hereby claimed, and the aforementioned application is hereby incorporated herein by reference.

### ACKNOWLEDGMENT OF GOVERNMENT SUPPORT

Not applicable.

### BACKGROUND OF THE INVENTION

### Field of the Invention

The present invention relates generally to bicycle steering systems, and more particularly to a direct underseat steering (USS) assembly for recumbent bicycles.

### Description of Related Art

The advantages of recumbent bicycles over traditional upright bicycles are well known. Due to the lower riding position, recumbents produce less wind resistance than uprights. And, recumbents can be substantially more comfortable than uprights, due to a reclining position and a seating area that spreads the rider's weight over a much larger area.

Despite these inherent advantages, recumbents continue to represent only a small niche in the larger bicycle industry. There are several categories of reasons for the limited appeal of current recumbent designs.
Unwieldiness. For commuters and riders in urban settings, maneuverability and light weight are important. But, two major classes of recumbent bicycles-long wheelbase designs, and tricycles—are difficult to operate in narrow spaces.
Cost. The retail price of recumbent bicycles exceeds the willingness and ability to pay of an average bicycle rider. The high prices for recumbents are partly due to their design and partly due to low sales volumes. Examples of design elements that increase costs include differently sized front and rear wheels, complex steering mechanisms (e.g., USS with cable- or rod-driven linkages), two-stage transmissions, and boom-style frames that require high-performance materials.
Inefficiency. In general, the “efficiency” of a bicycle refers to the amount of forward motion generate per unit of work effort. Although reduced wind resistance increases the efficiency of recumbent bicycles, other aspects of recumbent bicycles can reduce their efficiency. In conventional recumbent designs with the handlebars in front of the rider's chest, or designs with linkage-based USS, the recumbent rider can only apply limited effort from their arms and back. Also, complex chainlines (e.g. two-stage transmissions, or idler wheels) increase friction and reduce efficiency.
Social unacceptability. Recumbent bicycles, and their riders, are perceived as strange, and there is a widespread (and somewhat deserved) perception of recumbents as being dangerous due to poor visibility to drivers. The regulations of cycle racing's governing bodies also perpetuate the traditional upright diamond frame.

Steering systems for recumbent bicycles present design challenges. Most recumbent designs use above-seat steering (ASS), but that arrangement creates aerodynamic drag, limits the pedaling force that can be generated with the rider's arms and shoulders, and can result in fatigue in the arms and shoulders on long rides. Underseat steering (USS) systems avoid those problems, but standard USS designs rely on complex linkages, which can reduce efficiency, add weight, reduce responsiveness, and increase susceptibility to crash damage. A need exists for a direct USS system that is mechanically simple, reliable, and allows free handlebar movement between the frame and drivetrain components.

The goal of the present invention is to create a bicycle that enjoys the full advantages inherent in recumbent design, while avoiding the key pitfalls. The present invention is compatible with a short wheelbase design, which allows for high maneuverability and everyday riding in urban situations. The present invention is also compatible with a straight chainline (no jockey wheels or transmissions) that is simple and efficient, and is compatible with common internally geared hubs. The steering assembly in the present invention allows the rider to ride with arms in a straight or locked position, similar to a typical stationary exercise bicycle, and contribute force from his arms, shoulders, torso and back to propel the bicycle. The steering assembly is also mechanically simple and durable, and highly responsive to the rider's input.

Of interest to the present invention are several existing disclosures. Turner et al., U.S. Pat. No. 4,333,664, discloses a recumbent bicycle with direct USS, which was marketed as the “Hypercycle.” The Hypercycle has been criticized for an excessively short wheelbase that places the rider's weight too far forward, thereby creating unsafe riding conditions when braking heavily or going over rough terrain. McElfresh et al., U.S. Pat. Nos. 4,618,160 and 4,778,192, discloses a short wheelbase USS recumbent bicycle that has a better weight distribution than Turner et al., but that relies on a complicated chainline and a complicated steering linkage mechanism.

Buckler et al., U.S. Pat. No. 4,925,203, discloses a bicycle with direct USS and a simple chainline. The key shortcoming of Buckler et al. is that the wheelbase is even shorter and the front wheel is even smaller than Turner et al., which exacerbates the safety risks and makes the bicycle unsafe and inefficient for many purposes. Belik et al., U.S. Pat. No. 5,620,196, discloses an ASS recumbent bicycle that, in its main embodiment, has a simple chainline, although the frame design puts the rider in a substantially vertical position which creates aerodynamic inefficiency. Belik et al.'s alternative embodiment achieves greater aerodynamic efficiency, but requires a more-complex chainline.

White, U.S. Pat. No. 10,435,102, discloses a direct USS steering assembly for a recumbent bicycle that is compatible with a short wheelbase and a relatively simple chainline. The two key limitation of White's design are poor steering “feel,” due to the use of an asymmetrical wraparound connector, and excessive susceptibility to damage of the steering assembly in the event of a minor crash.

The goals of the current invention are to allow a design that combines a short wheelbase (for maneuverability and operation in tight urban spaces), direct USS (for mechanical simplicity and “feel”), equal-sized front and rear wheels (for ease of maintenance and to overcome social objections to recumbent bicycles), and a straight chainline (for efficiency of operation and simplicity of manufacturing). Achieving that combination requires 1) placing the seat immediately above the top section of the chain (which transmits power under pedaling, and extends from the top of the rear sprocket to the top of the front chainring), 2) having the bottom section of the chain (extending from the bottom of the front chainring to the bottom of the rear sprocket) pass just above the front brakes, and 3) having the handlebars rotate freely between the upper and lower sections of the chain, and between the upper and lower members of the frame. In order to place the seat immediately above the upper section of the chain and for the handlebars to rotate freely under the seat, the handlebar must rotate below the upper section of the chain and must be attached to the front forks in a way that is different from conventional upright bicycle design, and that is what is described in this disclosure.

### SUMMARY OF THE INVENTION

The present invention provides a direct USS assembly for a recumbent bicycle. The assembly includes a Y-shaped steering connector coupled through a head tube with cutouts, allowing the handlebar to rotate freely between the upper and lower sections of the chain and between upper and lower frame members. This configuration reduces mechanical complexity, improves rider feedback, and enhances durability compared to linkage-based systems.

In one embodiment, the Y-shaped connector attaches to the steering tube via compression and bolt fittings. In other embodiments, variations in materials, cutout geometry, and connection methods may be employed.

### BRIEF DESCRIPTION OF THE DRAWINGS

FIG. 1—a right-side perspective view of an example vehicle

FIG. 2—a partial right-side view of the steering assembly

FIG. 3—a partial right-side exploded view of the steering assembly

FIG. 4—a partial top view of the steering assembly

FIG. 5—a right-side view of the Y-shaped connector and the head tube with cutouts

FIG. 6—a top side view of the Y-shaped connector and the head tube with cutouts

FIG. 7—a rear side view of the Y-shaped connector and the head tube with cutouts

### LIST OF PARTS

10 recumbent bicycle
12 Y-shaped connector
14 head tube with cutouts
16 handlebar
18 right-side main stay
20 left-side main stay
22 down tube
24 chain
26 steering tube
28 lower section of Y-shaped connector
30 upper section of Y-shaped connector
32 upper cutout
34 lower cutout
36 upper bolt hole
38 lower bolt hole
40 opening for handlebar
42 upper tab
44 lower tab
46 upper cutout to allow compression
48 lower cutout to allow compression
50 left bolt holes through upper and lower tabs
52 right bolt holes through upper and lower tabs

### DESCRIPTION OF EMBODIMENT

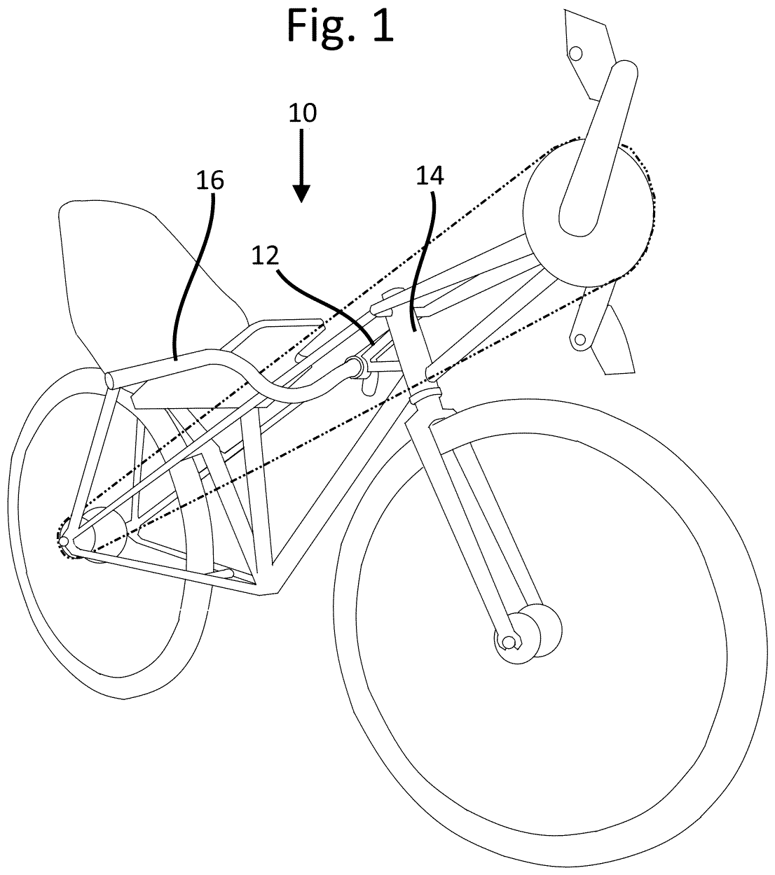

A recumbent bicycle 10 of this invention is shown in FIG. 1. As shown in FIG. 1, the handlebar 16 is attached to a Y-shaped connector 12. The Y-shaped connector 12 is attached to the steering tube 26 (not visible in FIG. 1) through a head tube 14 with cutouts.

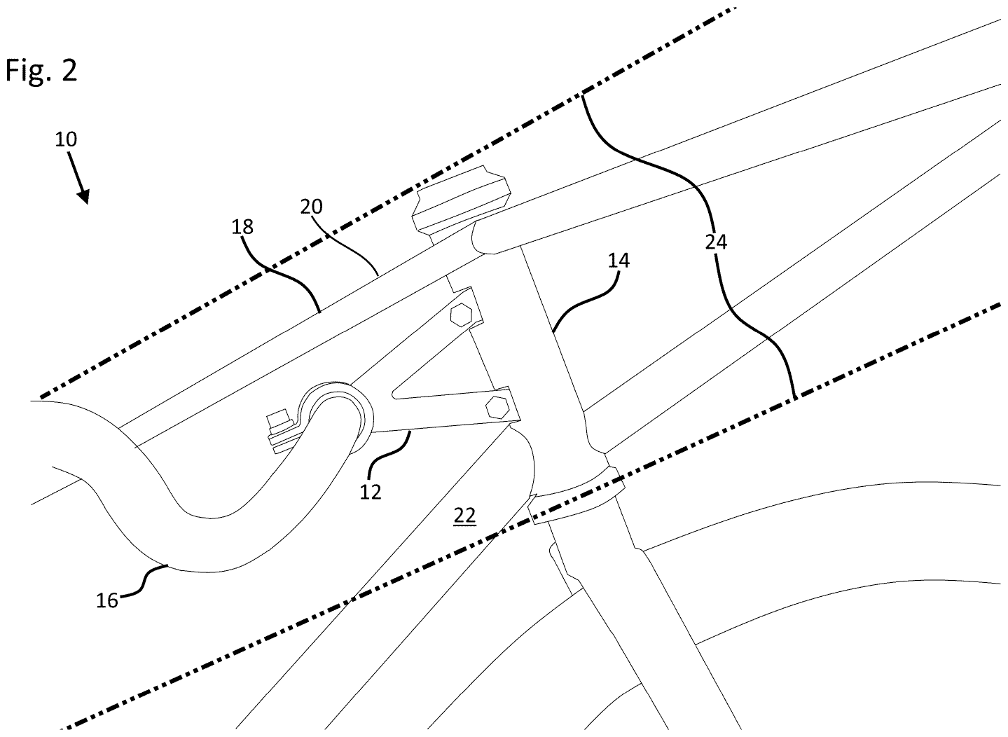

As shown in FIG. 2, the handlebar 16 is attached to the Y-shaped connector 12 and the Y-shaped connector is attached to the steering tube 26 (not visible in FIG. 2) through cutouts in the head tube 14. This connection allows the handlebar to rotate freely between the upper frame parts—the right main side stay 18 and the left main side stay 20 (not visible in FIG. 2)—and the down tube 22, and between the upper and lower sections of the chain 24.

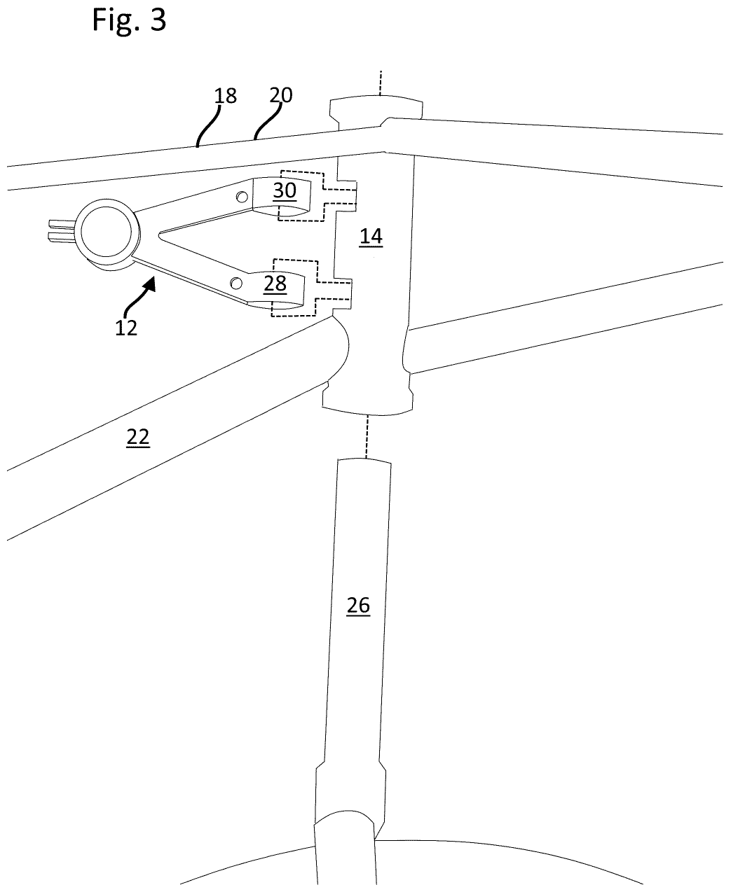

In FIG. 3, the dashed line shows how the steering tube 26 first passes through the lower end of the head tube 14, then through the lower section of the Y-shaped connector 28, then through the middle of the head tube 14, then through the upper end of the Y-shaped connector 30, then through the upper end of the head tube 14. The steering tube then connects to the upper headset bearing (not shown).

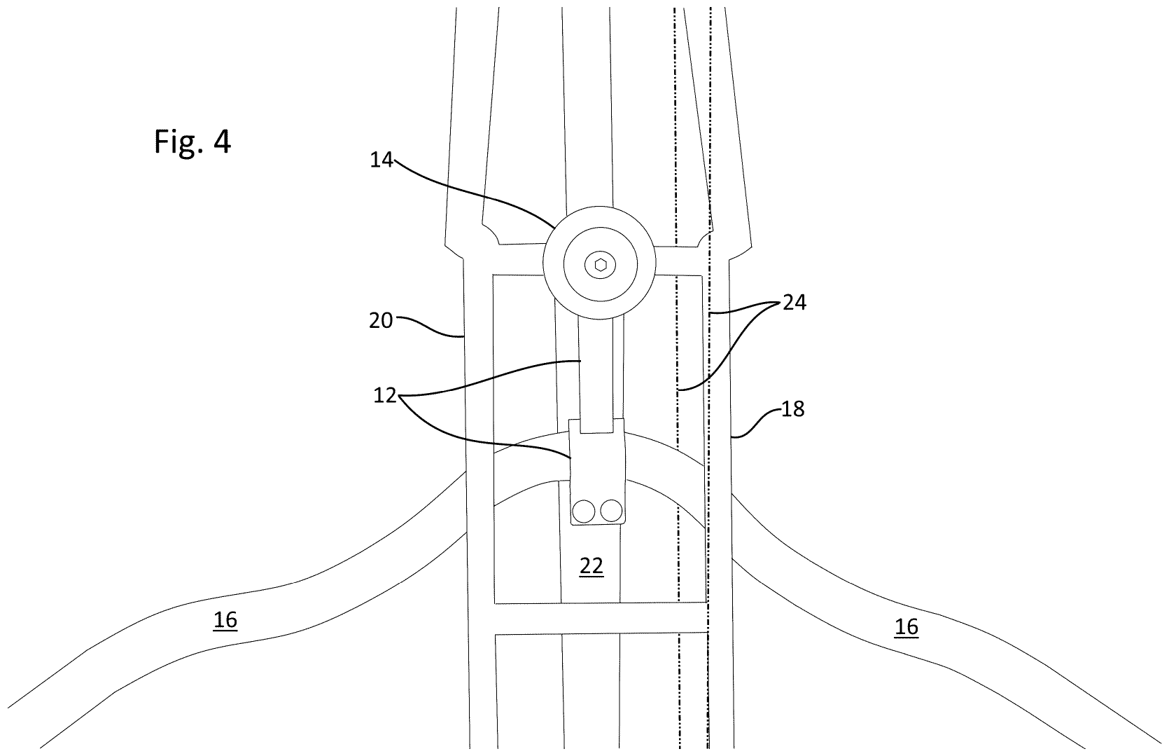

FIG. 4 shows the Y-shaped connector 12 extending rearward from the head tube 14 and connecting to the handlebar 16.

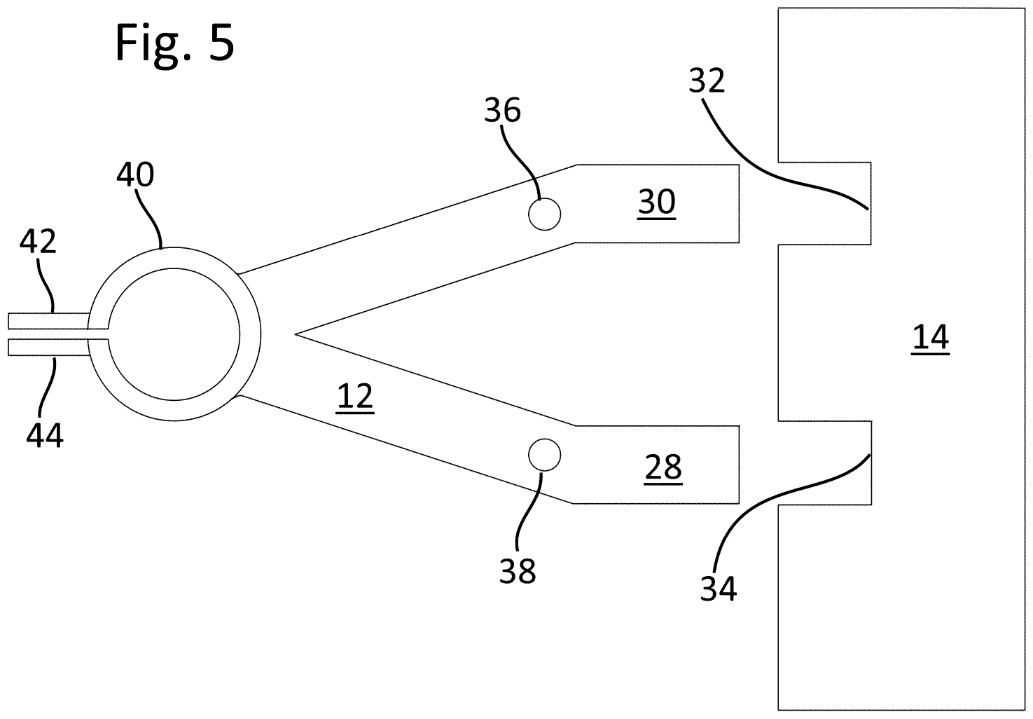

FIG. 5 shows the upper cutout 32 of the head tube 14 and the lower cutout 34 of the head tube 14. So that the Y-shaped connector 12 can be attached to the steering tube 26, the upper section 30 of the Y-shaped connector 12 passes through the upper cutout 32 of the head tube 14, and the lower section 28 of the Y-shaped connector 12 passes through the lower cutout 34 of the head tube 14. FIG. 5 also shows the upper bolt hole 36 and lower bolt hole 38 of the Y-shaped connector 12. Those bolt holes allow mounting hardware to pass through the Y-shaped connector and to firmly attach the Y-shaped connector to the steering tube 26.

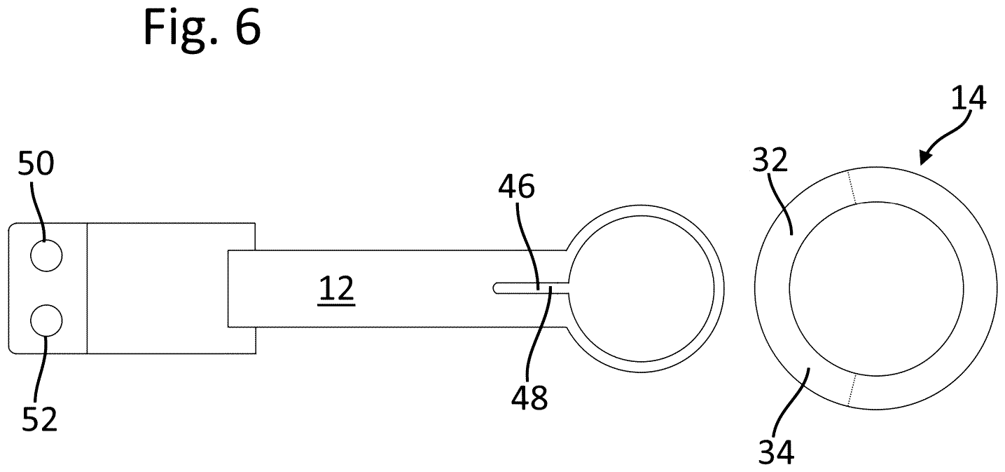

FIG. 6 uses dashed lines to indicate the arc of the head tube 14 that is removed to form the upper cutout 32 and the lower cutout 34. The Y-shaped connector 12 has a cutout 46 in the center of the upper section of the Y-shaped connector 30, and a cutout 48 in the center of the lower section of the Y-shaped connector 28. Those cutouts allow the mounting hardware that is passed through the upper bolt hole 36 and through the lower bolt hole 38 to compress the Y-shaped connector and firmly attach it to the steering tube 26. The upper tab 42 of the Y-shaped connector and the lower tab 44 of the Y-shaped connector each has a left bolt hole 50 and a right bolt hole 52. The bolt holes 50 and 52 allow mounting hardware to pass through and compress the upper tab 42 and lower tab 44 to firmly attach the Y-shaped connector 12 to the handlebar 16.

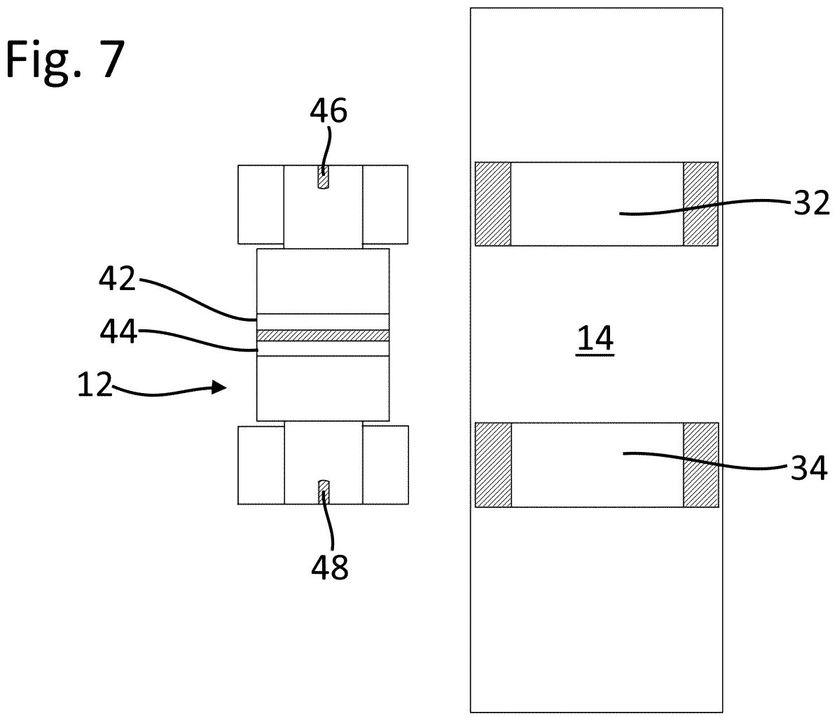

FIG. 7 shows the upper cutout 32 and the lower cutout 34 of the head tube 14. FIG. 7 also shows the upper tab 42 and lower tab 44 of the Y-shaped connector, and the upper cutout 46 for compression and the lower cutout 48 for compression of the Y-shaped connector 12.

### Alternative Embodiments

Alternative embodiments could include a head tube with one large cutout rather than two smaller cutouts, which would weaken the head tube but would simplify manufacturing. Another alternative embodiment would be a connector that, rather than being Y-shaped, is I-shaped, meaning that the part of the connector attached to the steering tube is one connected piece rather than split. That alternative embodiment would sacrifice either strength or weight or both, and would require one large cutout rather than two smaller cutouts. Another alternative embodiment would include a covering that maintains free rotation of the steering tube but limits entry of rain, dirt and other contaminants into the head tube.

### Advantages

The invention allows a rider to operate a bicycle in a recumbent position, and to steer the bicycle using a direct USS system. The recumbent position, compared to the typical upright riding position, greatly reduces air resistance and the work required for forward motion. Compared to linkage-based USS systems, the direct USS system is mechanically simpler and easier to manufacture, offers better feedback to the rider, and is and less likely to be damaged in a crash. The invention includes a Y-shaped steering connector and head tube with cutouts. Those components allow the handlebar to rotate freely between the upper and lower sections of the chain, and between the upper and lower members of the bicycle frame. In the event of a crash, if sudden high forces are acting on the handlebars, the Y-shaped connector can rotate relative to the steering tube, and the handlebars can rotate relative to the Y-shaped connector. Those rotations will absorb the crash forces and avoid permanent damage to the steering assembly.

### Operation

In operation, the rider grips the handlebar 16 positioned under the seat. Rotational movement of the handlebar is transmitted directly through the Y-shaped connector 12 and steering tube 26 to the front fork and wheel, allowing intuitive and responsive steering.

### Manufacturing and Assembly

The Y-shaped connector may be fabricated by machining, casting, welding, or additive manufacturing. The head tube with cutouts may be fabricated starting with head tube stock and then removing the cutouts either by milling, punch and die, or a flat-pattern cut before rolling and welding the tube. Components may be heat-treated or surface-finished for durability. Assembly involves inserting the steering tube 26 through the head tube 14 and Y-shaped connector 12, tightening bolts through holes 36, 38, and securing handlebar 16 via bolt holes 50, 52.

### VARIATIONS AND MODIFICATIONS

Although described with reference to specific embodiments, the invention encompasses variations including different handlebar geometries, connection hardware, or chainline clearances, all within the scope of the appended claims.

What is claimed is:

1. A steering assembly for a bicycle comprising:
a. A head tube with one or more cutouts allowing a connector to be rotatably attached and removably attached to the steering tube between the upper and lower ends of the head tube, and
b. A connector that is rotatably attached and removably attached to the steering tube through the head tube cutout or cutouts, and is rotatably attached and removably attached to the handlebars.

2. The steering assembly of claim 1, further comprising a head tube with two cutouts and a connector that is Y-shaped.

3. The steering assembly of claim 1, further comprising a Y-shaped connector that rotates freely in the vertical space between an upper frame member and a lower frame member, wherein said upper frame member consists of a single top tube or a pair of side tubes, and wherein said lower frame member consists of a down tube.

4. The steering assembly of claim 1, further comprising a Y-shaped connector that rotates between the upper and lower sections of the bicycle chain.
